(19) United States
(12) Patent Application Publication
(10) Pub. No.: US 2026/0155149 A1
(43) Pub. Date: Jun. 4, 2026

(54) UTILIZING LARGE LANGUAGE MODEL(S) TO PROVIDE FLEXIBLE VOICE INTERFACES

(71) Applicant: GOOGLE LLC, Mountain View, CA (US)

(72) Inventors: Alex Olwal, Santa Cruz, CA (US); Anoop K. Sinha, Palo Alto, CA (US); Shaun K. Kane, Broomfield, CO (US)

(21) Appl. No.: 19/406,385

(22) Filed: Dec. 2, 2025

Related U.S. Application Data
(60) Provisional application No. 63/727,520, filed on Dec. 3, 2024.

(51) Int. Cl. G10L 15/26; G06F 40/103; G10L 15/183; G10L 15/22

(52) U.S. Cl. CPC G10L 15/26; G06F 40/103; G10L 15/183; G10L 15/22

(57) ABSTRACT

Implementations relate to receiving natural language (NL) input associated with a client device; processing, using a first large language model (LLM), first LLM input to generate corresponding first LLM output, the first LLM input including the NL input; identifying, based on the corresponding first LLM output, a dictation portion of the NL input and an instruction portion of the NL input, where the instruction portion includes one or more instructions for transcription of the dictation portion; processing, using the first LLM or a second LLM, second LLM input to generate corresponding second LLM output, the second LLM input including the dictation portion and the instruction portion; determining, based on the corresponding second LLM output, a transcription of the dictation portion responsive to the one or more instructions for transcription of the dictation portion; and causing the transcription of the dictation portion to be rendered at the client device.

### BACKGROUND

Various generative models (GM(s)) have been proposed that can be used to process image content, video content, audio content, natural language (NL) content and/or other input(s), to generate output that reflects generative content that is responsive to the input(s). As one example, large language models (LLM(s)) have been developed that can be used to process NL content and/or other input(s), to generate LLM output that reflects generative NL content and/or other content that is responsive to the input(s). As another example, multi-modal GM(s) have been developed that can be used to process NL content and/or other input(s) (e.g., image data, video data, and/or audio data), to generate outputs that reflect generative NL content and/or other content (e.g., image data, video data, and/or audio data) that is responsive to the input(s).

The capabilities of LLM(s) and/or GM(s) can be leveraged as part of voice interfaces which allow users to interact with client devices via spoken voice inputs. For example, users of client devices can use spoken voice inputs to interact with a wide variety of applications, automated assistants, GM(s), etc. accessible at client devices via voice interfaces. However, current voice interfaces may suffer from one or more drawbacks. As one example, current voice interfaces may be inflexible, in that they do not adapt to the vocabulary, style, and context of individual users. As another example, current voice interfaces may be inaccurate, in that they fail to accurately transcribe a user's voice input (and provide inefficient or inadequate tools for correcting these inaccuracies). These drawbacks may be exacerbated for users with particular accessibility needs and for users who interact with voice interfaces whilst simultaneously performing other tasks (e.g., driving, cycling, or walking). Processing inputs to voice interfaces using LLM(s), for example, can provide voice interfaces with improved flexibility and accuracy amongst other technical benefits.

### SUMMARY

Implementations disclosed herein are directed to utilizing large language model(s) (LLM(s)) to provide flexible, adaptable, and accurate voice interfaces. More particularly, but not exclusively, techniques are described herein for leveraging LLM(s) to: identify aspects of spoken voice inputs which a user provides as direct input to a voice interface (generally referred to herein as “dictation” input(s) or “dictation” portions of input(s)); identify any aspects of spoken voice inputs (or any other inputs) which a user provides as indirect instruction to the voice interface (generally referred to herein as “instruction” input(s) or “instruction” portions of input(s)); and process the dictation input(s) in view of the instruction input(s) (e.g., to transcribe a dictation input in accordance with particular instruction(s) regarding the form or style that this transcription should take).

In various implementations, natural language (NL) input associated with a client device may be received. In other words, processor(s) of a system can be configured to receive an input including free-form NL input, e.g., a spoken voice input from a user of the client device. At least a portion of the NL input may be an input directed towards a voice interface, e.g., a voice interface provided at the client device for interacting with one or more applications, automated assistants, or generative models (GMs). As a specific example, the NL input may be a user query requesting dictation of an input for a note-taking application accessible at the client device. For instance, the NL input may be “Write me a shopping list including bread, eggs, and milk. Make it a bulleted list.” It will be appreciated that the NL input can include a single spoken voice input or multiple spoken voice inputs received at the client device. In some instances, the NL input may take the form of raw audio data or a raw video data capturing the spoken voice input(s). In some instances, raw audio/video data captured at the client device may be processed using automatic speech recognition (ASR) techniques (e.g., using an ASR model which could optionally be separate from the LLM(s) described herein), and the NL input may take the form of outputted ASR data corresponding to the spoken voice input(s).

First LLM input may be processed using a first LLM to generate corresponding first LLM output. The first LLM input may include the NL input. A dictation portion of the NL input and an instruction portion of the NL input may be identified based on the corresponding first LLM output. The instruction portion of the NL input may include one or more instructions for transcription of the dictation portion of the NL input. In other words, an LLM (e.g., the first LLM) can be configured to receive an input including the NL input, and can be trained to process the input to provide output which identifies a dictation portion of the NL input (e.g., a textual input for a voice interface at the client device) and which identifies an instruction portion of the NL input (e.g., instruction(s) for how the textual input for the voice interface at the client device should be transcribed or otherwise processed). It will be appreciated that an LLM (e.g., the first LLM) can be trained/fine-tuned and prompted to do this in a variety of ways. For example, the LLM can be trained based on a number of training instances, where each training instance includes a mapping between an NL input and the dictation portion and the instruction portion of this NL input. These training instances can be human generated and/or synthetically generated.

Returning to the specific example given above, the LLM can identify that the dictation portion of the NL input is “ . . . bread, eggs, and milk” and the instruction portion of the NL input is “Write me a shopping list . . . . Make it a bulleted list”. In other words, the LLM can be trained/fine-tuned and prompted to recognize that the user's intention is to input the dictation portion of the NL input as a textual input for the note-taking application, but the user does not intend to input the instruction portion of the NL input as a textual input for the note-taking application. Rather, the user intends the instruction portion of the NL input to be used to cause the dictation portion to be transcribed according to a particular formatting style (i.e., a bullet point shopping list).

Optionally, the system can cause an initial transcription (e.g., an ASR transcription) of the dictation and/or instruction portions of the NL input to be rendered as output at the client device (e.g., visually and/or audibly), allowing the user to ensure that the dictation and/or instruction portions of the NL input have been correctly identified. This may allow the user of the client device an opportunity to confirm that the dictation and/or instruction portions have been correctly identified, or to provide feedback correcting the dictation and/or instruction portions of the NL input. For example, this feedback could also be received through the voice interface, or could be received as input at a keyboard or other interface of the client device. The dictation and/or instruction portions of the NL input can be updated to take account of any correctional feedback.

Second LLM input may be processed using the first LLM or a second LLM to generate corresponding second LLM output. The second LLM input may include the dictation portion of the NL input and the instruction portion of the NL input. A transcription of the dictation portion of the NL input responsive to the one or more instructions for transcription of the dictation portion of the NL input may be determined based on the corresponding second LLM output. In other words, an LLM (e.g., the same, first LLM or a different, second LLM) can be configured to receive an input including both the dictation portion of the NL input and the instruction portion of the NL input, and can be trained to process the input to provide output representative of a transcription of the dictation portion of the NL input which is responsive to the one or more instructions for transcription of the dictation portion of the NL input. It will be appreciated that an LLM (e.g., the first LLM or the second LLM) can be trained/fine-tuned and prompted to do this in a variety of ways. For example, the LLM can be trained based on a number of training instances, where each training instance includes a mapping between the dictation portion and the instruction portion of an NL input, and a transcription of the dictation portion of the NL input which is responsive to the one or more instructions for transcription of the dictation portion of the NL input. These training instances can be human generated and/or synthetically generated.

Returning to the specific example given above, the LLM can transcribe the dictation portion of the NL input (i.e., “ . . . bread, eggs, and milk”) as a shopping list in the form of a bullet point list, as specified by the instruction portion of the NL input. For example, this could be transcribed as follows:

### Shopping List

Bread
Eggs
Milk

The transcription of the dictation portion of the NL input may be caused to be rendered at the client device. For example, the transcription of the dictation portion of the NL input can be rendered as visual output (e.g., on a display of the client device) and/or as audible output (e.g., via a speaker of the client device). Returning to the specific example given above, the bullet point shopping list may be rendered as visual output on a display of the client device by the note-taking application.

It will be appreciated that although the above specific example is given with respect to a particular NL input and particular instruction(s), the techniques described herein are applicable to a wide range of scenarios. In some examples, the instructions for transcription of the dictation portion of the NL input may include one or more formatting instructions. For instance, as described above, these formatting instructions may include an instruction to format some or all of the dictation portion using bullet points and correspondingly, the transcription of the dictation portion may include formatted text in the form of bullet point(s). As another example, these formatting instructions may include an instruction to format some or all of the dictation portion using a list (e.g., numbered lists, checklists, nested lists, etc.) and correspondingly, the transcription of the dictation portion may include formatted text in the form of a list. As another example, these formatting instructions may include an instruction to format some or all of the dictation portion according to a punctuation guideline (e.g., punctuated as speech, punctuated as a question, punctuated in brackets, etc.) and correspondingly, the transcription of the dictation portion may include text formatted in line with the punctuation guideline. As another example, these formatting instructions may include an instruction to format some or all of the dictation portion according to a structure guideline (e.g., structured as C++ code, structured as a poem, structured as rough notes, etc.) and correspondingly, the transcription of the dictation portion may include text formatted in line with the structure guideline. As another example, these formatting instructions may include an instruction to extract specific information from the dictation portion and correspondingly, the transcription of the dictation portion may include the specific extracted information.

In some examples, the instructions for transcription of the dictation portion of the NL input may include one or more correction instructions. These types of instructions may be particularly applicable in scenarios with ‘real-time’ transcription where, for example, a real-time transcription of the spoken voice input is displayed at a client device in real-time as the user continues speaking. For instance, these correction instructions may include an instruction to correct one or more formatting errors in the dictation portion (e.g., missing or misplaced punctuation, etc.) and correspondingly, the transcription of the dictation portion may remove these one more formatting errors (e.g., compared to the real-time transcription). As another example, these correction instructions may include an instruction to correct one or more spelling errors in the dictation portion (e.g., misspelled names, etc.) and correspondingly, the transcription of the dictation portion may remove these one or more spelling errors (e.g., compared to the real-time transcription). As another example, these correction instructions may include an instruction to correct one or more recognition errors in the dictation portion (e.g., misidentified words, etc.) and correspondingly, the transcription of the dictation portion may remove these one or more recognition errors (e.g., compared to the real-time transcription).

In some examples, the instructions for transcription of the dictation portion of the NL input may include one or more shortcut instructions. For instance, these shortcut instructions may include an instruction to replace a portion (referred to herein as a “shortcut portion”) of the dictation portion with a shortcut and correspondingly, the transcription of the dictation portion may include the shortcut in lieu of the shortcut portion. As one example, the shortcut portion of the dictation portion could be a reference to a website, and the shortcut could be a selectable hyperlink to that website, such that the transcription of the dictation portion includes the selectable hyperlink to the website. As another example, the shortcut portion of the dictation portion and the shortcut could correspond to previously saved information, (e.g., the shortcut portion of the dictation could be a reference to an address of a contact, and the shortcut could be the full saved address of that contact), such that the transcription of the dictation portion includes the full saved address of the contact.

In various implementations, instruction(s) for transcription of an NL input may be received as separate input(s), e.g., as instruction input(s) separate from the NL input itself. Specifically, NL input associated with a client device may be received, and one or more instruction inputs associated with the NL input may be identified. A classification of each of these instruction input(s) (e.g., a classification of the particular type or modality of the instruction input) may be determined based on an instruction input mapping. This instruction input mapping may map the classification(s) (e.g., the particular type or modality of the instruction input) to particular instruction(s). In this manner, it may be possible to map particular instruction(s) from particular instruction inputs(s) according to the instruction input mapping, which can be specifically set up/updated by a user, or machine learned over time.

These particular instructions may include, for example, any of the formatting, correction, and/or shortcut instructions described above, or instructions for the activation of particular “modes”, such as a dictation mode (e.g., for indicating that any NL input received in the dictation mode should be treated as textual input for the voice interface) and/or an instruction mode (e.g., for indicating that any NL input received in the instruction mode should be treated as instruction(s) for how other textual input(s) for the voice interface should be transcribed or otherwise processed).

For example, these input types or modalities may include one or more keyboard inputs (e.g., pressing particular keys on a keyboard of the client device, etc.), one or more mid-air gesture inputs (e.g., waving a hand in front of a camera or proximity sensor of the client device, etc.), one or more physical button inputs (e.g., pressing particular buttons on the client device, etc.), one or more inertial measurement unit (IMU) inputs (e.g., shaking the client device, tilting the client device, etc.), one or more touchscreen inputs (e.g., selecting an element displayed on a touchscreen of the client device, etc.), and/or one or more mouse inputs (e.g., using a mouse to click on an element on a display of the client device, etc.).

In many scenarios, using voice interfaces to input text (e.g., as part of an interaction with a wide variety of applications, automated assistants, GM(s), etc.) can lead to computationally inefficient and time-consuming human-computer interactions. Using the techniques described herein may provide a variety of technical advantages. Specifically, the techniques described herein can reduce the duration of time and/or number of inputs needed for human-computer interactions for inputting formatted text via a voice interface. For example, these techniques can eliminate the need for a user to go back and edit and/or format text which has been input via a voice interface using complicated and frustrating editing and/or formatting interfaces. Instead, the user can include natural language instruction input(s) for formatting text via the voice interface along with their dictation input(s) (i.e., along with the text itself). These instruction input(s) can be provided, for example, as part of the same NL input as the dictation input(s), or via any of the other input types or modalities described above. Providing the formatting instructions directly along with dictation text may be both a faster (e.g., in terms of speed of input via the voice interface and/or in terms of computational processing) and more accurate way of providing formatting instructions, rather than relying on computationally inefficient, secondary, editing and/or formatting interfaces.

These techniques can also allow a user to provide customized and/or personalized instruction input(s) for formatting text via a voice interface. As explained above, a user can, for example, set up an instruction input mapping which correlates particular instructions with particular input types or modalities such that the user can e.g., press a particular key to enter a dictation mode, or e.g., provide a particular mid-air hand gesture to format text as a list. This ability to utilize a variety of modalities to provide customized instructions can be particularly beneficial for people with accessibility needs (which, for example, may prevent them from easily operating traditional keyboard-based editing interfaces in a computationally efficient or timely manner). The techniques described herein can utilize LLM(s) to provide a flexible, adaptable, and accurate voice interface which allows a user to provide editing and/or formatting instructions in a computationally efficient manner. Further, the improved voice interfaces described herein can be used to provide improved input mechanisms for a wide range of applications, including note-taking, document editing, navigation, music, and automated assistant applications.

The above description is provided as an overview of some implementations of the present disclosure. Further description of those implementations, and other implementations, is provided below in more detail.

### BRIEF DESCRIPTION OF THE DRAWINGS

FIG. 1 depicts a block diagram of an example environment that demonstrates various aspects of the present disclosure, and in which some of the implementations disclosed herein can be implemented.

FIG. 2A and FIG. 2B depict process flows for utilizing various components from the example environment of FIG. 1, in accordance with various implementations.

FIG. 3 depicts a flowchart that illustrates an example method of utilizing large language model(s) (LLM(s)) to process natural language (NL) input to provide a flexible, adaptable, and accurate voice interface.

FIG. 4 depicts a flowchart that illustrates an example method of utilizing LLM(s) to process NL input and one or more instruction inputs to provide a flexible, adaptable, and accurate voice interface.

FIG. 5A, FIG. 5B, and FIG. 5C depict various non-limiting examples of utilizing large language model(s) (LLM(s)) to provide flexible, adaptable, and accurate voice interfaces.

FIG. 6 depicts an example architecture of a computing device, in accordance with various implementations.

### DETAILED DESCRIPTION

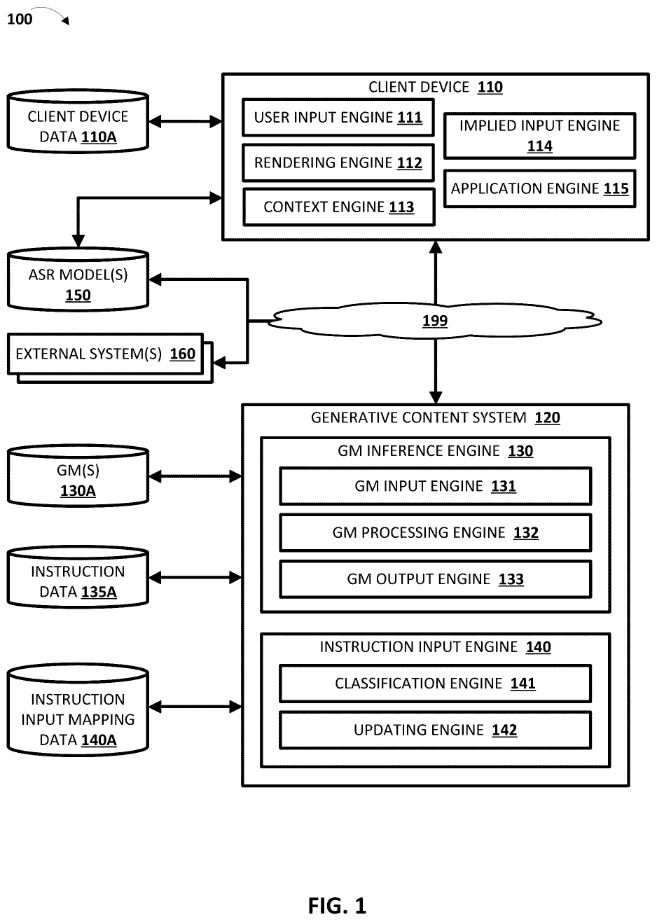

Turning now to FIG. 1, a block diagram of an example environment 100 that demonstrates various aspects of the present disclosure, and in which implementations disclosed herein can be implemented is depicted. The example environment 100 includes a client device 110 and a generative content system 120. The example environment 100 also includes automated speech recognition (ASR) model(s) 150 and external system(s) 160.

In some implementations, all or aspects of the generative content system 120 can be implemented locally at the client device 110. In additional or alternative implementations, all or aspects of the generative content system 120 can be implemented remotely from the client device 110 as depicted in FIG. 1 (e.g., at remote server(s)). In those implementations, the client device 110 and the generative content system 120 can be communicatively coupled with each other via one or more networks 199, such as one or more wired or wireless local area networks (“LANs”, including Wi-Fi LANs, mesh networks, Bluetooth, near-field communication, etc.) or wide area networks (“WANs”, including the Internet). Similarly, ASR model(s) 150 can be implemented locally at the client device 110 and/or can be implemented remotely from the client device 110 (with the client device 110 and the ASR model(s) 150 communicatively coupled with each other via the one or more networks 199). Similarly, external system(s) 160 can be implemented locally at the client device 110 and/or can be implemented remotely from the client device 110 (with the client device 110 and the external system(s) 160 communicatively coupled with each other via the one or more networks 199).

The client device 110 can be, for example, one or more of: a desktop computer, a laptop computer, a tablet, a mobile phone, a computing device of a vehicle (e.g., an in-vehicle communications system, an in-vehicle entertainment system, an in-vehicle navigation system), a standalone interactive speaker (optionally having a display), a smart appliance such as a smart television, and/or a wearable apparatus of the user that includes a computing device (e.g., a watch of the user having a computing device, glasses of the user having a computing device, a virtual or augmented reality computing device). Additional and/or alternative client devices may be provided.

The client device 110 can execute one or more software applications, via application engine 115, through which NL inputs, touch inputs, and/or other user inputs (e.g., including the various ‘NL inputs’ and ‘instruction inputs’ referred to herein, such as NL inputs 201 and/or 211, and/or instruction input 212) can be provided and/or selected, and/or content that is responsive to the NL inputs, touch inputs, and/or other user inputs (e.g., including the various ‘transcriptions’ referred to herein, such as transcriptions 208 and/or 216) can be rendered (e.g., visually and/or audibly). The application engine 115 can execute one or more software applications that are separate from an operating system of the client device 110 (e.g., installed “on top” of the operating system) - or can alternatively be implemented directly by the operating system of the client device 110. For example, the application engine 110 can execute a web browser, generative application (e.g., a generative note-taking application), or automated assistant installed on top of the operating system of the client device 110. As another example, the application engine 115 can execute a web browser software application, a generative software application (e.g., a generative note-taking application), or automated assistant software application that is integrated as part of the operating system of the client device 110. The application engine 115 (and the one or more software applications executed by the application engine 115) can interact with or otherwise provide access to (e.g., act as a front-end for) the generative content system 120.

In various implementations, the client device 110 can include a user input engine 111 that is configured to detect user input provided by a user of the client device 110 using one or more user interface input devices. For example, the client device 110 can be equipped with one or more microphones that capture audio data, such as audio data corresponding to spoken utterances of the user or other sounds in an environment of the client device 110. Additionally, or alternatively, the client device 110 can be equipped with one or more vision components that are configured to capture vision data corresponding to images and/or movements (e.g., gestures) detected in a field of view of one or more of the vision components. Additionally, or alternatively, the client device 110 can be equipped with one or more touch sensitive components (e.g., a keyboard and mouse, a stylus, a touch screen, a touch panel, one or more hardware buttons, etc.) that are configured to capture signal(s) corresponding to touch input directed to the client device 110. Additionally, or alternatively, the client device 110 can be equipped with one or more inertial measurement unit (IMU) components (e.g., an accelerometer) that are configured to capture signal(s) corresponding to movement of the client device 110. Some instances of input data described herein can be input data that is formulated based on user input provided by a user of the client device 110 and detected via user input engine 111. For example, a query can be typed via a physical or virtual keyboard, a suggested query that is selected via a touch screen or a mouse, a spoken voice query that is detected via microphone(s) of the client device, or an image query that is based on an image captured by a vision component of the client device or an image stored in a memory of the client device.

Some instances of input (e.g., NL inputs 201 and/or 211) can be a query for a response that is formulated based on user input provided by a user of the client device 110 and detected via user input engine 111. For example, the query can be a typed query that is typed via a physical or virtual keyboard, a suggested query that is selected via a touch screen or a mouse of the client device 130A, a spoken voice query that is detected via microphone(s) of the client device 130A (and optionally directed to an automated assistant executing at least in part at the client device 110), or an image or video query that is based on vision data captured by vision component(s) of the client device 110 (or based on NL input generated based on processing the image using, for example, object detection model(s), captioning model(s), etc.). Other instances of NL input described herein can be a prompt for content that is formulated based on user input provided by a user of the client device 110 and detected via the user input engine 111. For example, the prompt can be a typed prompt that is typed via a physical or virtual keyboard, a suggested prompt that is selected via a touch screen or a mouse of the client device 110, a spoken prompt that is detected via microphone(s) of the client device 110, or an image or video prompt that is based on an image or video captured by a vision component of the client device 110.

In various implementations, the client device 110 can utilize one or more machine learning (ML) model(s) to process the user input. For example, the user input received at the client device 110 can be a spoken utterance. In these examples, the user input engine 110 can process, using ASR model(s) 150 (e.g., a recurrent neural network (RNN) model, a transformer model, and/or any other type of ML model capable of performing ASR), audio data that captures the spoken utterance and that is generated by microphone(s) of the client device 110 to generate ASR output. The ASR output can include, for example, speech hypotheses (e.g., term hypotheses and/or transcription hypotheses) that are predicted to correspond to the spoken utterance captured in the audio data, one or more corresponding predicted values (e.g., probabilities, log likelihoods, and/or other values) for each of the speech hypotheses, a plurality of phonemes that are predicted to correspond to the spoken utterance captured in the audio data, one or more corresponding predicted values (e.g., probabilities, log likelihoods, and/or other values) for each of the plurality of phonemes, and/or other ASR output. In these implementations, the user input engine 111 can select one or more of the speech hypotheses as recognized text that corresponds to the spoken utterance (e.g., based on the corresponding predicted values for each of the speech hypotheses), such as when the user input engine 111 utilizes an end-to-end ASR model. In other implementations, the user input engine 111 can select one or more of the predicted phonemes (e.g., based on the corresponding predicted values for each of the predicted phonemes), and determine recognized text that corresponds to the spoken utterance based on the one or more predicted phonemes that are selected, such as when the user input engine 111 utilizes an ASR model that is not end-to-end. In these implementations, the user input engine 111 can optionally employ additional mechanisms (e.g., a directed acyclic graph) to determine the recognized text that corresponds to the spoken utterance based on the one or more predicted phonemes that are selected.

Notably, although the ASR model(s) 150 are described above as being implemented locally by the client device 110, it should be understood that is for the sake of example and is not meant to be limiting. For instance, the audio data that captures the spoken utterance can additionally, or alternatively, be streamed to the generative content system 120 and/or external system(s) 160, and the generative content system 120 and/or external system(s) 160 can utilize the ASR model(s) described above (or separate cloud-based ASR model(s)) to generate the ASR output.

In various implementations, the client device 110 can include a rendering engine 112 that is configured to provide content (e.g., transcriptions 208 and/or 216) for audible and/or visual presentation to a user of the client device 110 using one or more user interface output devices. For example, the client device 110 can be equipped with one or more speakers that enable content to be provided for audible presentation to the user via the client device 110. Additionally, or alternatively, the client device 110 can be equipped with a display or projector that enables content to be provided for visual presentation to the user via the client device 110.

In various implementations, the client device 110 can include a context engine 113 that is configured to determine a context (e.g., current or recent context) of the client device 110 and/or of a user of the client device 110. In some of those implementations, the context engine 113 can determine a context utilizing current or recent interaction(s) via the client device 110, a location of the client device 110, profile data of a profile of a user of the client device 110 (e.g., an active user when multiple profiles are associated with the client device 110), and/or other data accessible to the context engine 113. For example, the context engine 113 can determine a current context based on a current state of a query session (e.g., considering one or more recent queries of the query session), profile data, and/or a current location of the client device 110. For instance, the context engine 113 can determine a current context of “looking for a healthy lunch restaurant in Louisville, Kentucky” based on a recently issued query, profile data, and a location of the client device 110. As another example, the context engine 113 can determine a current context based on which application is active in the foreground of the client device 110, a current or recent state of the active application, and/or content currently or recently rendered by the active application. A context determined by the context engine 113 can be utilized, for example, in supplementing or rewriting a query that is formulated based on user input, in generating an implied query (e.g., a query formulated independent of user input), and/or in determining to submit an implied query and/or to render result(s) for an implied query.

In various implementations, the client device 110 can include an implied input engine 114 that is configured to: generate an implied query independent of any user input directed to formulating the implied query; to submit an implied query, optionally independent of any user input that requests submission of the implied query; and/or to cause rendering of result(s) for an implied query, optionally independent of any user input that requests rendering of the result(s)). For example, the implied input engine 114 can use current context, from context engine 113, in generating an implied query, determining to submit the implied query, and/or in determining to cause rendering of result(s) for the implied query. For instance, the implied input engine 114 can automatically generate and automatically submit an implied query based on the current context. Further, the implied input engine 114 can automatically push result(s) to the implied query to cause them to be automatically rendered or can automatically push a notification of the result(s), such as a selectable notification that, when selected, causes rendering of the result(s). As another example, the implied input engine 114 can generate an implied query based on profile data (e.g., an implied query related to an interest of a user), submit the query at regular or non-regular intervals, and cause corresponding result(s) for the submission(s) to be automatically provided (or a notification thereof automatically provided).

Further, the client device 110 and/or the generative content system 120 can include one or more memories for storage of data and/or software applications, one or more processors for accessing data and executing the software applications, and/or other components that facilitate communication over one or more of the networks 199. In some implementations, one or more of the software applications can be installed locally at the client device 110, whereas in other implementations one or more of the software applications can be hosted remotely (e.g., by one or more servers) and can be accessible by the client device 110 over one or more of the networks 199.

Although aspects of FIG. 1 are illustrated or described with respect to a single client device having a single user, it should be understood that is for the sake of example and is not meant to be limiting. For example, one or more additional client devices of a user and/or of additional user(s) can also implement the techniques described herein. For instance, the client device 110, one or more additional client devices, and/or any other computing devices of a user can form an ecosystem of devices that can employ techniques described herein. These additional client devices and/or computing devices may be in communication with the client device 110 (e.g., over the network(s) 199). As another example, a given client device can be utilized by multiple users in a shared setting (e.g., a group of users, a household).

The generative content system 120 is illustrated in FIG. 1 as including a generative model (GM) inference engine 130 and an instruction input engine 140. Some of the engines can be omitted in various implementations. In some implementations, the engines of the generative model response system are distributed across one or more computing systems and/or the engines of the generative model response system include one or more sub-engines. For instance, the GM inference engine 130 is illustrated in FIG. 1 as including a GM input engine 131, a GM processing engine 132, and a GM output engine 133, and the instruction input engine 140 is illustrated in FIG. 1 as including a classification engine 141 and an updating engine 142. Similarly, some of these sub-engines can be combined and/or omitted in various implementations. Accordingly, it should be understood that the various engines and sub-engines of the generative content system 120 illustrated in FIG. 1 are not meant to be limiting. The generative content system 120 can be used to implement one or more of the LLMs described herein; in particular the LLM(s) (e.g., stored in GM(s) database 130A) used for processing NL inputs and/or generating responsive transcriptions. These LLM(s) used for processing NL inputs and/or generating responsive transcriptions are interchangeably described herein as cloud-based LLM(s), but this is not meant to be limiting (e.g., one or more of these LLM(s) and/or all or aspects of the generative content system 120 may alternatively be implemented locally at the client device 110).

Further, the generative content system 120 is illustrated in FIG. 1 as interfacing with various databases, such as GM(s) database 130A, instruction database 135A, and instruction input mapping database 140A. GM inference engine 130 may have access to at least GM(s) database 130A and instruction input engine 140 may have access to at least instruction input mapping database 140A. However, it should be understood that this is for the sake of example and is not meant to be limiting. For instance, in some implementations, each of the various engines and/or sub-engines of the generative content system 120 can have access to each of the various databases. Further, some of these databases can be combined and/or omitted in various implementations. Accordingly, it should be understood that the various databases interfacing with the generative content system 120 illustrated in FIG. 1 are not meant to be limiting. Client device 110 is also illustrated in FIG. 1 as interfacing with client device database 110A, which may store data associated with the client device and/or users of the client device (e.g., on the client device 110, or remotely from the client device 110).

Moreover, the generative content system 120 can interface with other system(s), such as external system(s) 160. The external system(s) 160 can include, for example, search system(s) (e.g., text-based search system(s), image-based search system(s), video-based search system(s), etc.) and/or other generative system(s) (other text-based generative system(s), other image-based generative system(s), other video-based generative system(s), other audio-based generative system(s), etc.) and/or other tools or functions (e.g., systems for implementing ASR, optionally using ASR model(s) 150). In some implementations, the external system(s) 160 are first-party system(s), whereas in other implementations, the external system(s) 160 are third-party system(s). As used herein, the term “first-party” or “first-party entity” refers to an entity that controls, develops, and/or maintains the generative content system 120, whereas the term “third-party” or “third-party entity” refers to an entity that is distinct from the entity that controls, develops, and/or maintains the generative content system 120.

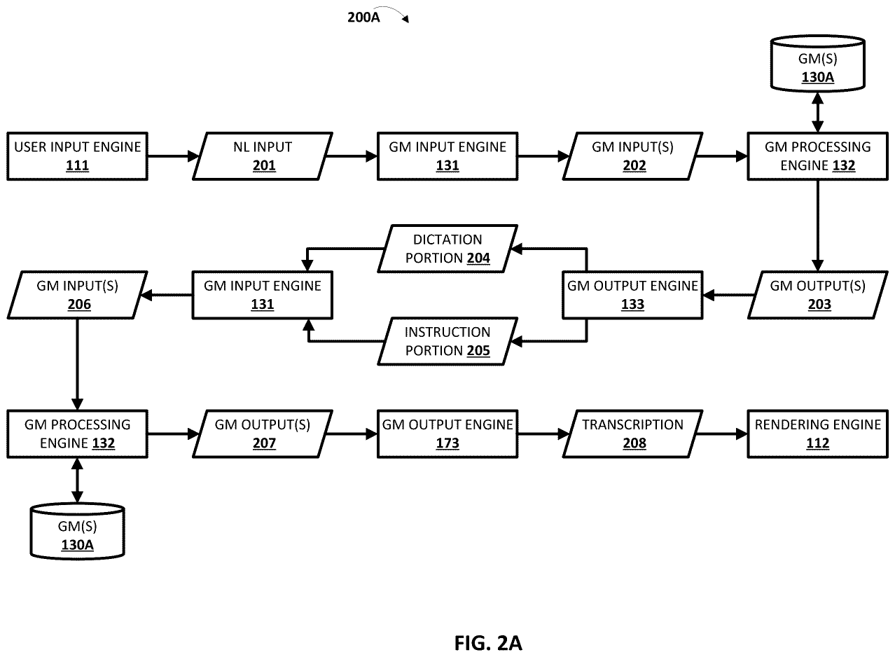

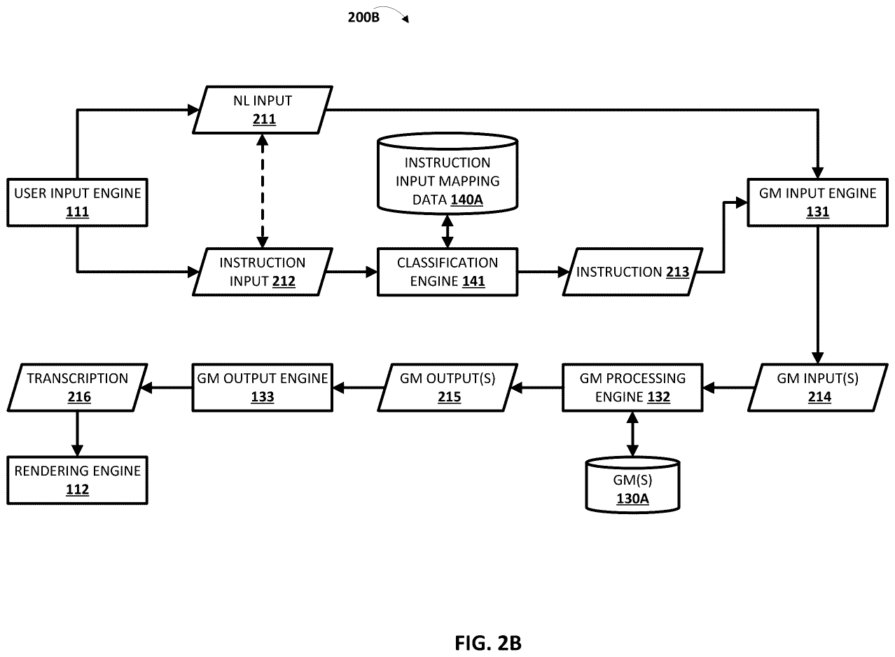

As described in more detail herein (e.g., with respect to FIGS. 2A, 2B, 3, 4, 5A, 5B, and 5C), the generative content system 120 can be utilized for processing NL inputs (e.g., NL inputs 201 and/or 211) and/or generating responsive transcriptions (e.g., transcriptions 208 and/or 216). Specifically, the generative content system 120 can access GM(s) (e.g., the first and/or second LLMs described herein) which can be used to process GM input including the NL input(s). The generative content system 120 can use the GM inference engine 130 to perform this processing. Based on corresponding GM output, transcriptions which are responsive to certain instructions (which may optionally be stored in instruction database 135A) for transcribing the NL input(s) can be determined.

The GM input engine 131 can, in response to receiving query/input data (e.g., including NL inputs 201 and/or 211, and/or instruction input 212), generate model input that is to be processed using GM(s) (e.g., the first and/or second LLMs described herein). As described herein, such query/input data (e.g., including the NL inputs 201 and/or 211, and/or instruction input 212) can include any combination of input prompt(s), one or more images, one or more portions of video data, one or more portions of audio data, and/or one or more portions of text data. For example, NL inputs 201 and/or 211, and/or instruction input 212 may include a reference to one or more images, one or more portions of video data, one or more portions of audio data, and/or one or more portions of text data, and the query/input data may include both the NL inputs 201 and/or 211, and/or instruction input 212 and the referenced one or more images, one or more portions of video data, one or more portions of audio data, and/or one or more portions of text data. The input data can optionally include additional content, such as contextual information. The GM input engine 131 can, for example, reformat input data into a suitable form for processing using GM(s), e.g., reformat an input NL query as a prompt suitable for an LLM, etc.

The GM processing engine 132 can process input data that is generated by the GM input engine 131 using appropriate GM(s) (e.g., the first and/or second LLMs described herein) to generate response/output data. Such response/output data (e.g., the “GM output” referred to herein) can include a distribution over e.g., a set of potential outputs, etc., based on processing the query/input data using one or more GM(s).

The GM output engine 153 can determine, based on the response/output data, content generated using the GM(s) for further use in the methods described herein. Such content (e.g., the dictation portion 204 and/or instruction portion 205, and/or the transcriptions 208 and/or 216 referred to herein, which may be determined from the “GM output”) can be determined by sampling the distributions described above.

The instruction input engine 140 can be used to identify particular instruction(s) associated with particular input(s). For example, instruction input(s) 212 can include a variety of input types or modalities, including keyboard inputs, mid-air gesture inputs, physical button inputs, IMU inputs, touchscreen inputs, and/or mouse inputs. The instruction input engine 140 can use classification engine 141 to classify the particular type or modality corresponding to the instruction input (e.g., depressing the shift key on a keyboard may be a first classification, waving a hand from side to side in front of a camera may be a second, different, classification, etc.). The particular mapping between the classification of the input type and the corresponding instruction(s) may be defined by an instruction input mapping (optionally stored in instruction input mapping database 140A). A variety of possible instructions (and e.g., information regarding how to carry out these instructions, etc.) may be stored in instruction database 135A. The updating engine 142 can be used, for example, to update or change the correspondences between particular input(s) and particular instructions(s) defined by the instruction input mapping.

Turning now to FIGS. 2A and 2B, process flows for utilizing various components from the example environment of FIG. 1 are depicted. Referring specifically to FIG. 2A, and for the sake of example, assume that a user provides NL input 201 via user input engine 111 of client device 110. Although the process flow 200A of FIG. 2A is described with respect to NL input 201 being an explicit NL input, it should be understood that this is for the sake of example and is not meant to be limiting. For instance, all or aspects of NL input 201 can be implied NL input (e.g., as described with respect to implied input engine 114). For example, the user may provide a dictation as part of NL input 201, and the instruction portion of the NL input 201 may be implied (i.e., automatically generated based on context, historical data, etc.), or vice versa.

The GM input engine 131 can, in response to receiving input data (e.g., including NL input 201), generate model input that is to be processed using GM(s) (e.g., the first LLM, optionally stored in GM(s) database 130A) in generating a response to the input data.

The GM processing engine 132 can process, using one or more LLM(s) from the GM(s) database 130A the GM input(s) 202 to generate the GM output(s) 203. In these implementations, the GM output(s) 203 can include a probability distribution over a sequence of tokens, such as words, phrases, or other semantic units that are predicted to be necessary for determining the dictation portion 204 and the instruction portion 205 from the NL input 201. The LLM(s) can include millions or billions of weights and/or parameters that are learned through training the LLM(s) on enormous amounts of diverse data. This enables the LLM(s) to generate the GM output(s) 203 as the probability distribution over the sequence of tokens. The LLM(s) can be initially trained and/or fine-tuned to enable the LLM(s) to generate the GM output including the probability distribution over the sequence of tokens.

The GM output engine 133 can determine, based on the GM output(s) 203, the dictation portion 204 of the NL input and the instruction portion 205 of the NL input. For example, the dictation portion 204 and the instruction portion 205 can be determined by sampling the probability distribution(s) described above.

The dictation portion 204 of the NL input and the instruction portion 205 of the NL input can be received as input at GM input engine 131 (i.e., second LLM input referred to herein). The GM input engine 131 can, in response to receiving input data (e.g., including the dictation portion 204 and the instruction portion 205), generate model input that is to be processed using GM(s) (e.g., the first LLM or a second LLM, optionally stored in GM(s) database 130A) in generating a response to the input data.

The GM processing engine 132 can process, using one or more LLM(s) from the GM(s) database 130A the GM input(s) 206 to generate the GM output(s) 207. In these implementations, the GM output(s) 207 can include a probability distribution over a sequence of tokens, such as words, phrases, or other semantic units that are predicted to be necessary for determining the transcription 208 of the dictation portion 204 of the NL input which is responsive to instruction(s) from instruction portion 205. The LLM(s) can include millions or billions of weights and/or parameters that are learned through training the LLM(s) on enormous amounts of diverse data. This enables the LLM(s) to generate the GM output(s) 207 as the probability distribution over the sequence of tokens. The LLM(s) can be initially trained and/or fine-tuned to enable the LLM(s) to generate the GM output including the probability distribution over the sequence of tokens.

The GM output engine 133 can determine, based on the GM output(s) 207, the transcription 208 of the dictation portion 204 of the NL input which is responsive to instruction(s) from instruction portion 205. For example, the transcription 208 can be determined by sampling the probability distribution(s) described above.

The transcription 208 can be provided to the client device for rendering (e.g., visually and/or audibly). The rendering engine 112 can render the transcription 208 at the client device 110. For example, a textual transcription 208 can be rendered for display as a visual output at a display of client device 110.

Referring specifically to FIG. 2B, and for the sake of example, assume that a user provides NL input 211 via user input engine 111 of client device 110, and also provides instruction input 212 (which is associated with (e.g., received concurrently to) the NL input 211) via the user input engine 111. Although the process flow 200B of FIG. 2B is described with respect to NL input 211 and the instruction input 212 being an explicit inputs, it should be understood that this is for the sake of example and is not meant to be limiting. For instance, all or aspects of NL input 211 can be implied NL input (e.g., as described with respect to implied input engine 114), and all or aspects of instruction input 212 can be implied instruction input. For example, instruction input 212 may be implied (i.e., automatically generated based on context, historical data, etc.). As a specific example, implied instruction inputs may be generated to correct regular misspellings, recognition failures, etc.

The classification engine 141 can, in response to receiving input data (e.g., including instruction input 212), classify the instruction input 212 using an instruction input mapping (optionally stored in instruction input mapping database 140A). Based on the identified classification of the instruction input 212, the classification engine 141 can further identify instruction(s) that correspond to this classification (e.g., including instruction 213).

The NL input 211 and the instruction 213 can be received as input at GM input engine 131. The GM input engine 131 can, in response to receiving input data (e.g., including the NL input 211 and the instruction 213), generate model input that is to be processed using GM(s) (e.g., an LLM, which may be the same as one of the first or second LLMs described herein, optionally stored in GM(s) database 130A) in generating a response to the input data.

The GM processing engine 132 can process, using one or more LLM(s) from the GM(s) database 130A the GM input(s) 214 to generate the GM output(s) 215. In these implementations, the GM output(s) 215 can include a probability distribution over a sequence of tokens, such as words, phrases, or other semantic units that are predicted to be necessary for determining the transcription 216 of the NL input which is responsive to instruction 213. The LLM(s) can include millions or billions of weights and/or parameters that are learned through training the LLM(s) on enormous amounts of diverse data. This enables the LLM(s) to generate the GM output(s) 215 as the probability distribution over the sequence of tokens. The LLM(s) can be initially trained and/or fine-tuned to enable the LLM(s) to generate the GM output including the probability distribution over the sequence of tokens.

The GM output engine 133 can determine, based on the GM output(s) 215, the transcription 216 of the NL input which is responsive to the instruction 213. For example, the transcription 216 can be determined by sampling the probability distribution(s) described above.

The transcription 216 can be provided to the client device for rendering (e.g., visually and/or audibly). The rendering engine 112 can render the transcription 216 at the client device 110. For example, a textual transcription 216 can be rendered for display as a visual output at a display of client device 110.

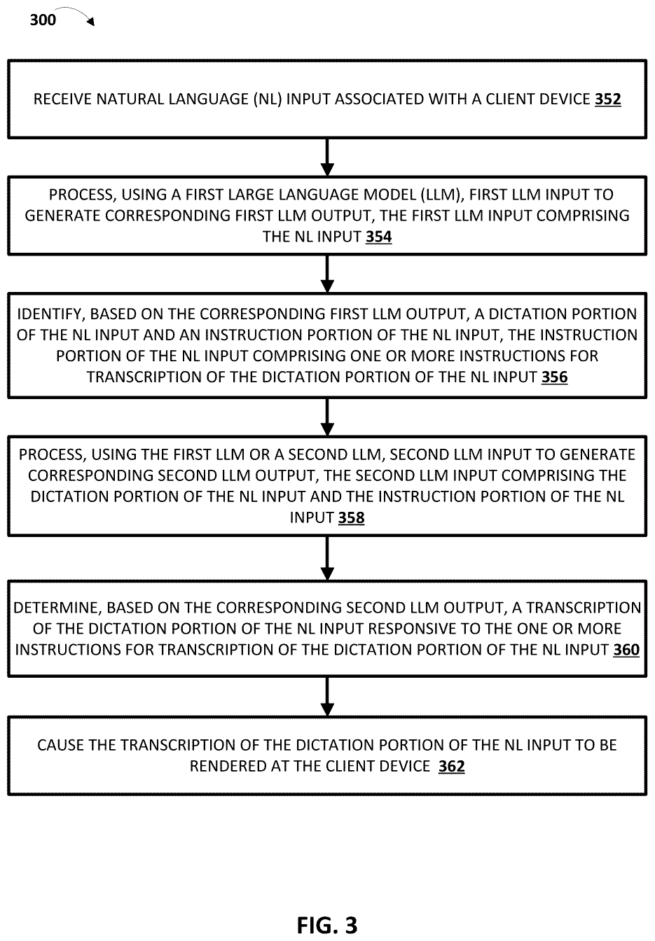

Turning now to FIG. 3, a flowchart is depicted that illustrates an example method 300 for utilizing large language model(s) (LLM(s)) to process natural language (NL) input to provide a flexible, adaptable, and accurate voice interface. The method 300 generally corresponds to the process flow 200A described in relation to FIG. 2A. For convenience, the operations of the method 300 are described with reference to a system that performs the operations. This system of the method 300 includes one or more processors, memory, and/or component(s) of computing device(s). Moreover, while operations of the method 300 are shown in a particular order, this is not meant to be limiting. One or more operations may be reordered, omitted, and/or added.

At block 352, the system receives NL input associated with a client device. As described with respect to the user input engine 111 of FIG. 1, free form NL input can be received through a variety of means. For example, the client device 110 can be equipped with one or more microphones that capture audio data, and the NL input can include a spoken utterance (i.e., a spoken voice input) of a user captured in audio data by the one or more microphones. At least a portion of the NL input may be intended as direct, dictation, input to a voice interface, and at least a portion of the NL input may be intended as indirect, instruction, input to the voice interface. This “instruction” portion can provide instruction(s) as to how the “dictation” portion should be processed and/or transcribed (e.g., with respect to the form or style that this transcription should take). It will be appreciated that the system may be able to recognize NL inputs which take this form using a variety of means. For example, the LLM(s) described herein may be trained and/or prompted to identify NL inputs which take this form and process them using the methods described herein (e.g., method 300). As another example, software application(s) described herein may be trained and/or prompted to identify NL inputs which take this form using a variety of means, including various machine-learned and/or heuristic techniques.

In some scenarios, NL input may refer to raw audio data and/or raw video data which captures the spoken utterance (i.e., the method 300 can involve processing raw audio data and/or raw video data using LLM(s)). In additional or alternative scenarios, NL input may refer to automatic speech recognition (ASR) data which corresponds to the spoken voice input (i.e., the method 300 can involve processing ASR data using LLM(s), where this ASR data is e.g., derived from the raw audio data and/or raw video data capturing the spoken utterance). As described in relation to the ASR model(s) 150 of FIG. 1, ASR techniques can be applied to spoken voice inputs directly at the client device 110 (e.g., using ASR model(s) 150), and/or ASR techniques can be applied to spoken voice inputs at systems which may be remote from the client device 110 (e.g., generative content system 120 and/or external system(s) 160).

At block 354, the system processes, using a first LLM, first LLM input to generate corresponding first LLM output. The first LLM input comprises the NL input. At block 356, the system identifies, based on the corresponding first LLM output, a dictation portion of the NL input and an instruction portion of the NL input. The instruction portion of the NL input comprises one or more instructions for transcription of the dictation portion of the NL input. For example, the generative content system 120 described with respect to FIG. 1 can be used to implement this processing using the first LLM. It will be appreciated that the first LLM can be trained/fine-tuned and/or prompted to process first LLM input including the NL input to identify the dictation portion and the instruction portion in a variety of ways. For example, the first LLM can be trained based on a number of training instances, where each training instance includes a mapping between an NL input and the dictation portion and the instruction portion of this NL input. These training instances can be human generated (e.g., using human labelling to create the training instances) and/or synthetically generated (e.g., using an LLM to generate the training instances).

In some examples, once the dictation portion and the instruction portion have been identified, an initial transcription of the dictation portion and the instruction portion can be rendered (e.g., visually and/or audibly) at the client device. For example, this can involve separating the dictation portion and the instruction portion and then providing a textual transcription of the dictation portion and/or the textual transcription of the instruction portion (i.e., before the dictation portion is transcribed in accordance with any particular instruction(s) provided in the instruction portion). This can allow a user the opportunity to identify (and optionally correct) any errors in the identification of the dictation portion and/or the instruction portion, e.g., an incorrect categorization of an instruction as part of the dictation portion, etc. The system may receive feedback (e.g., via the user input engine 111 of client device 110) which corrects the initial transcription of the dictation portion and/or corrects the initial transcription of the instruction portion. Responsive to this feedback, the system can update or correct the initial transcription of the dictation portion and/or the instruction portion, and use these updated/corrected portions as the basis for the remaining steps of the method 300 (i.e., for processing as part of the second LLM input at block 358).

The instruction(s) contained in the instruction portion (e.g., corresponding to instructions stored in instructions database 135A) can include a very wide range of possible instructions relating to formatting (e.g., how the transcription of the dictation portion should be presented and/or rendered), corrections (e.g., how the transcription of the dictation portion should be changed or corrected, optionally from the initial transcription, before being presented and/or rendered), and/or shortcuts (e.g., how the transcription of the dictation portion should incorporate “shortcuts” such as particular data, hyperlinks, etc.) associated with the dictation portion.

Formatting instruction(s) can include instruction(s) to: format the dictation portion of using bullet points, such that the transcription includes formatted bullet point text; format the dictation portion as a list, such that the transcription includes a formatted text list; format the dictation portion according to a particular punctuation guideline or style (e.g., punctuated as speech, punctuated as a question, punctuated in brackets, etc.) such that the transcription includes text formatted according to the punctuation guideline or style; format the dictation portion according to a particular structure guideline or style (e.g., structured as C++ code, structured as a poem, structured as rough notes, etc.), such that the transcription includes text formatted according to the structure guideline or style; format the dictation portion in a manner which extracts particular information from the dictation portion (e.g., extract keywords from a sentence to form rough notes, etc.), such that the transcription includes the extracted information.

Correction instruction(s) can include instruction(s) to: correct the dictation portion to remove particular formatting error(s) (e.g., missing or misplaced punctuation, etc.), such that the transcription does not include the formatting error(s); correct the dictation portion to remove particular spelling error(s) (e.g., misspelled names, etc.), such that the transcription does not include the spelling error(s); correct the dictation portion to remove particular recognition error(s) (e.g., misidentified words, etc.), such that the transcription does not include the recognition error(s).

Shortcut instruction(s) can include instruction(s) to: replace a shortcut portion (e.g., a reference to a website, a reference to an address of a contact, etc.) of the dictation portion with shortcut data (respectively, e.g., a hyperlink to that website, the full saved address of that contact, etc.), such that the transcription includes the shortcut data in lieu of the shortcut portion.

At block 358, the system processes, using the first LLM or a second LLM, second LLM input to generate corresponding second LLM output. The second LLM input comprises the dictation portion of the NL input and the instruction portion of the NL input. At block 360, the system determines, based on the corresponding second LLM output, a transcription of the dictation portion of the NL input responsive to the one or more instructions for transcription of the dictation portion of the NL input. For example, the generative content system 120 described with respect to FIG. 1 can be used to implement this processing using the first LLM (i.e., the same LLM which is used to identify the dictation portion and the instruction portion). In other examples, the generative content system 120 described with respect to FIG. 1 can be used to implement this processing using a second LLM (i.e., a different LLM from that which is used to identify the dictation portion and the instruction portion). It will be appreciated that the first (or second) LLM can be trained/fine-tuned and/or prompted to process the dictation and instruction portions to determine the transcription of the dictation portion in a variety of ways. For example, the first (or second) LLM can be trained based on a number of training instances, where each training instance includes a mapping between the dictation portion and the instruction portion of an NL input, and a transcription of the dictation portion of the NL input which is responsive to the one or more instructions for transcription of the dictation portion of the NL input. These training instances can be human generated (e.g., using human labelling to create the training instances) and/or synthetically generated (e.g., using an LLM to generate the training instances).

At block 362, the system causes the transcription of the dictation portion of the NL input to be rendered at the client device. The transcription may be rendered visually for display (e.g., where the transcription is responsive to visual-based transcription instructions, such as the use of bullet points, particular punctuation, etc.) and/or may be rendered audibly (e.g., where the transcription is responsive to transcription instructions which can be appreciated audibly, such as corrections or shortcuts). It will be appreciated that this arrangement provides a faster (e.g., in terms of speed of input via the voice interface and/or in terms of computational processing) and more accurate way of providing formatting, correction, or shortcut instructions, rather than relying on computationally inefficient, secondary, editing interfaces (e.g., keyboard based interfaces which may not be suitable for people with particular accessibility needs and/or people engaged in other activities simultaneously).

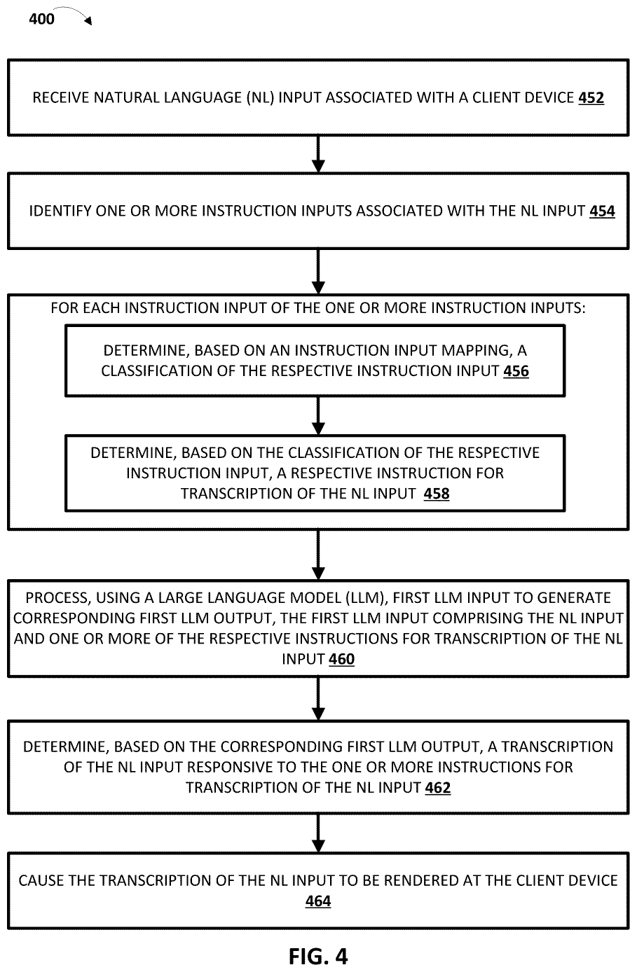

Turning now to FIG. 4, a flowchart is depicted that illustrates an example method 400 for utilizing LLM(s) to process NL input and one or more instruction inputs to provide a flexible, adaptable, and accurate voice interface. The method 400 generally corresponds to the process flow 200B described in relation to FIG. 2B. For convenience, the operations of the method 400 are described with reference to a system that performs the operations. This system of the method 400 includes one or more processors, memory, and/or component(s) of computing device(s). Moreover, while operations of the method 400 are shown in a particular order, this is not meant to be limiting. One or more operations may be reordered, omitted, and/or added.

At block 452, the system receives NL input associated with a client device. As described with respect to the user input engine 111 of FIG. 1, free form NL input can be received through a variety of means. For example, the client device 110 can be equipped with one or more microphones that capture audio data, and the NL input can include a spoken utterance (i.e., a spoken voice input) of a user captured in audio data by the one or more microphones. At least a portion of the NL input may be intended as direct, dictation, input to a voice interface.

In some scenarios, NL input may refer to raw audio data and/or raw video data which captures the spoken utterance (i.e., the method 400 can involve processing raw audio data and/or raw video data using LLM(s)). In additional or alternative scenarios, NL input may refer to automatic speech recognition (ASR) data which corresponds to the spoken voice input (i.e., the method 400 can involve processing ASR data using LLM(s), where this ASR data is e.g., derived from the raw audio data and/or raw video data capturing the spoken utterance). As described in relation to the ASR model(s) 150 of FIG. 1, ASR techniques can be applied to spoken voice inputs directly at the client device 110 (e.g., using ASR model(s) 150), and/or ASR techniques can be applied to spoken voice inputs at systems which may be remote from the client device 110 (e.g., generative content system 120 and/or external system(s) 160).

At block 454, the system identifies one or more instruction inputs associated with the NL input. These instruction input(s) may be intended as indirect, instruction, input to the voice interface. Specifically, these “instruction” input(s) can provide instruction(s) as to how the NL input should be processed and/or transcribed (e.g., with respect to the form or style that this transcription should take). It will be appreciated that the system may be able to recognize correspondence between NL input and instruction input(s) in a variety of ways. For example, the instruction input(s) may be received concurrently with, or applied to a specific portion of, the NL input (e.g., by providing an instruction input concurrently with speaking all of or part of the NL input). As another example, a user may specifically explain the NL input which the instruction input(s) relate to (e.g., as part of the NL input).

For each instruction input of the one or more instruction inputs, at block 456, the system determines, based on an instruction input mapping, a classification of the respective instruction input. Also, for each instruction input of the one or more instruction inputs, at block 458, the system determines, based on the classification of the respective instruction input, a respective instruction for transcription of the NL input. For example, the instruction input mapping may include a number of classifications, or categories, each of which corresponds to a different input type. These input types or modalities can include can include a huge variety of different input types, including (but not limited to) keyboard inputs (e.g., pressing particular keys on a keyboard of the client device, etc.), mid-air gesture inputs (e.g., waving a hand in front of a camera or proximity sensor of the client device, etc.), physical button inputs (e.g., pressing particular buttons on the client device, etc.), inertial measurement unit (IMU) inputs (e.g., shaking the client device, tilting the client device, etc.), touchscreen inputs (e.g., selecting an element displayed on a touchscreen of the client device, etc.), and/or mouse inputs (e.g., using a mouse to click on an element on a display of the client device, etc.). By identifying the particular type of each instruction input, a corresponding classification of the instruction input can be identified. This classification, in turn, can correspond to a particular instruction or set of instructions (optionally also stored as part of the instruction input mapping, e.g., stored in the instruction input mapping database 140A, and/or stored in the instruction database 135A) relating to how the corresponding NL input should be processed and/or transcribed. As such, each instruction input can effectively map to one or more instructions for how the NL input should be processed and/or transcribed.

The instruction(s) corresponding to the one or more instruction inputs (e.g., corresponding to instructions stored in instructions database 135A) can include a very wide range of possible instructions including all of those described above in relation to the method 300 illustrated in FIG. 3. Specifically, this can include instruction(s) relating to formatting (e.g., how the transcription of the dictation portion should be presented and/or rendered), corrections (e.g., how the transcription of the dictation portion should be changed or corrected, optionally from the initial transcription, before being presented and/or rendered), and/or shortcuts (e.g., how the transcription of the dictation portion should incorporate “shortcuts” such as particular data, hyperlinks, etc.) associated with the dictation portion. Additionally, this can include instruction(s) relating to a “dictation mode” (e.g., such that any NL input received concurrently with the dictation mode instruction is rendered as direct, dictation input to the voice interface) and/or an “instruction mode” (e.g., such that any NL input received concurrently with the instruction mode instruction is treated as indirect, instruction input to the voice interface for how to process and/or transcribe other aspects of the NL input).

It will be appreciated that this arrangement provides a flexible way in which users (e.g., each user of a client device) can customize, personalize, and adapt the way in which their NL inputs to a voice interface are processed and/or transcribed. For example, a user can pre-configure (e.g., via a software application on the client device 110) the instruction input mapping to, for example, use a particular button on the client device to indicate that a dictation mode should be used, or that shaking the client device should cause the current voice input to be formatted as a bullet point list, whilst other user(s) can pre-configured the instruction input mapping to cause these instruction inputs to correspond to different instruction(s). Moreover, the instruction input mapping can be changed or updated over time. For example, data for updating the instruction input mapping can be identified by the system. This data can be based on user input (e.g., an explicit user request received at the client device) to update the instruction input mapping, or can be machine-learned based on historical data (e.g., previous NL inputs and/or previous instruction inputs corresponding to those previous NL inputs received from the user at the client device). For instance, the system can update the instruction input mapping (or provide suggestions to the user for how the instruction input mapping could be updated) based on identified patterns between particular types of NL inputs and particular instructions. The system can update the instruction input mapping based on this data, e.g., such that the classifications align particular input types or modalities with particular instructions in a manner specified by the data.

At block 458, the system processes, using an LLM, first LLM input to generate corresponding first LLM output. The first LLM input comprises the NL input and one or more of the respective instructions for transcription of the NL input. At block 460, the system determines, based on the corresponding first LLM output, a transcription of the NL input responsive to the one or more instructions for transcription of the NL input. For example, the generative content system 120 described with respect to FIG. 1 can be used to implement this processing using an LLM. It will be appreciated that the LLM can be trained/fine-tuned and/or prompted to process the NL input and respective instruction(s) to determine the transcription of the NL input in a variety of ways. For example, the LLM can be trained based on a number of training instances, where each training instance includes a mapping between a NL input and respective instruction(s) for transcription of the NL input, and a transcription of the NL input which is responsive to the respective instruction(s) for transcription. These training instances can be human generated (e.g., using human labelling to create the training instances) and/or synthetically generated (e.g., using an LLM to generate the training instances).

At block 462, the system causes the transcription of the NL input to be rendered at the client device. The transcription may be rendered visually for display (e.g., where the transcription is responsive to visual-based transcription instructions, such as the use of bullet points, particular punctuation, etc.) and/or may be rendered audibly (e.g., where the transcription is responsive to transcription instructions which can be appreciated audibly, such as corrections or shortcuts).

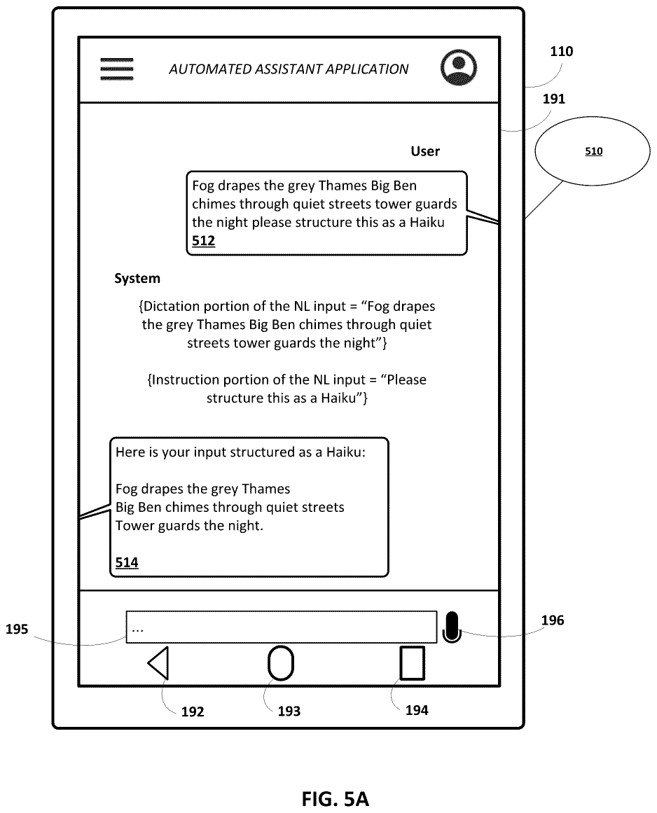

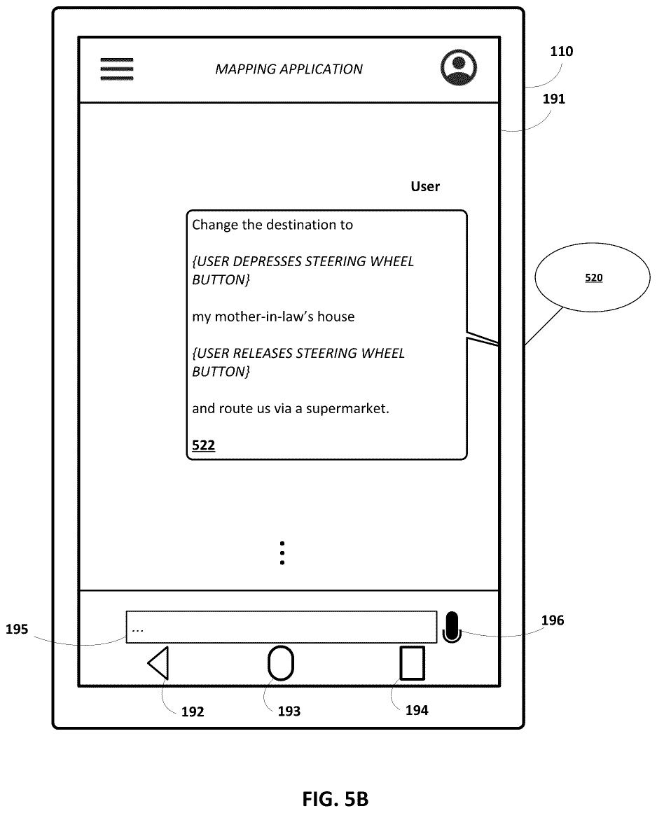

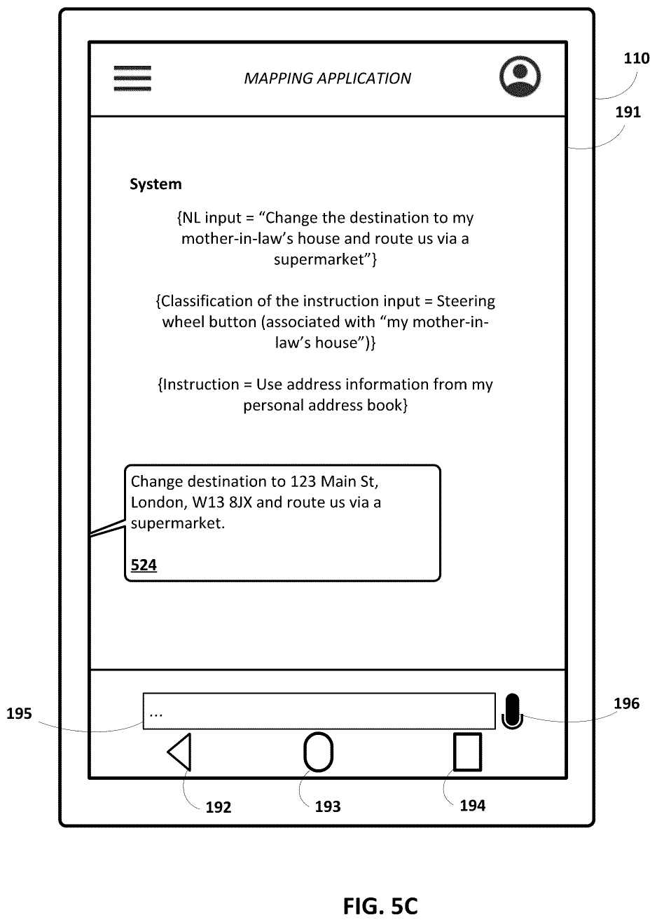

Turning now to FIGS. 5A, 5B, and 5C, various non-limiting examples of utilizing large language model(s) (LLM(s)) to provide flexible, adaptable, and accurate voice interfaces are depicted. A client device 110 (e.g., the client device 110 described with reference to FIGS. 1 and 2) may include various user interface components including, for example, microphone(s) to generate audio data based on spoken utterances and/or other audible input, speaker(s) to audibly render synthesized speech and/or other audible output, and/or a display 191 to visually render visual output. Further, the display 191 of the client device 110 can include various system interface elements 192, 193, and 194 (e.g., hardware and/or software interface elements) that may be interacted with by a user of the client device 110 to cause the client device 110 to perform one or more actions. The display 191 of the client device 110 enables the user to interact with content rendered on the display 191 by touch input (e.g., by directing user input to the display 191 or portions thereof (e.g., to a text entry box 195, to a keyboard (not depicted), or to other portions of the display 191)) and/or by spoken input (e.g., by selecting microphone interface element 196 - or just by speaking without necessarily selecting the microphone interface element 196 (i.e., an automated assistant may monitor for one or more terms or phrases, gesture(s) gaze(s), mouth movement(s), lip movement(s), and/or other conditions to activate spoken input) at the client device 110). Although the client device 110 depicted in FIGS. 5A, 5B, and 5C is a mobile phone, it should be understood that is for the sake of example and is not meant to be limiting. For example, the client device 110 may be a standalone speaker with a display, a standalone speaker without a display, a home automation device, an in-vehicle system, a laptop, a desktop computer, and/or any other device capable of executing an automated assistant to engage in a human-to-computer dialog session with the user of the client device 110.

Referring specifically to FIG. 5A, assume that a user of the client device 110 accesses an automated assistant application, via the client device 110, that enables the user to interact with a generative content system (e.g., the generative content system 120 of FIG. 1). Further assume that the user provides an NL input 512 (corresponding to spoken voice input 510 received at the client device 110) of “Fog drapes the grey Thames Big Ben chimes through quiet streets tower guards the night please structure this as a Haiku”. The automated assistant application, in this example, can be configured to process inputs using an LLM (e.g., the first LLM described herein) to accurately process and/or transcribe NL inputs provided by users.

By using the generative content system 120 (which e.g., may be implemented remotely from the client device 110, or may be implemented partially or wholly at the client device 110) to process the NL input using the first LLM, generative output which identifies a dictation portion of the NL input and which identifies an instruction portion of the NL input can be provided. In this specific example, it will be appreciated that an LLM can be trained/fine-tuned and prompted to identify that “Please structure this as a Haiku” is an instruction which refers to the previous dictation of “Fog drapes the grey Thames Big Ben chimes through quiet streets tower guards the night”. It will be appreciated that, in various implementations, the dictation portion and instruction portion shown in FIG. 5A are not rendered (e.g., visually and/or audibly) for presentation to the user, i.e., this information may not be perceivable by a user. However, in other implementations, the dictation portion and instruction portion may initially be rendered to the user (e.g., as plain text) in order to allow the user to provide feedback or correct either portion before any further processing.

Once the dictation portion and instruction portion have been identified, the generative content system 120 can process both portions using the first LLM (e.g., a multi-purpose, optionally foundation model), to provide generative output which identifies a transcription of the dictation portion which is responsive to the instruction(s) in the instruction portion. Assume that the system provides the user with a notification or message 514 saying:
“Here is your input structure as a Haiku:
Fog drapes the grey Thames
Big Ben chimes through quiet streets
Tower guards the night.”

In this specific example, it will be appreciated that an LLM can be trained/fine-tuned and prompted to identify that the common structure of a Haiku involves a structure guideline where the first line has 5 syllables, the second line has 7 syllables, and the third line has 5 syllables. As such, the dictation portion can be formatted across three lines with 5 syllables in the first line, 7 syllables in the second line, and 5 syllables in the third line to provide the final transcription (i.e., the dictation portion responsive to the instruction in the instruction portion) shown in message 514. The techniques described herein (and as illustrated with respect to FIG. 5A) may provide a variety of technical advantages. In particular, the techniques may reduce the duration of time and/or number of inputs needed for human-computer interactions for inputting formatted text via a voice interface. Specifically, by providing the formatting instructions as part of the same NL input as the dictation input, the user can receive formatted text faster (particularly in terms of speed of input via the voice interface) instead of having to use an inefficient, secondary, editing and/or formatting interface such as a keyboard interface to manually format the three lines, for example.

Referring specifically to FIG. 5B, again assume that a user of the client device 110 accesses a mapping (e.g., navigation) application, via the client device 110, that enables the user to interact with a generative content system (e.g., the generative content system 120 of FIG. 1). Further assume that the user is driving a car and simultaneously provides an NL input 522 (corresponding to spoken voice input 520 received at the client device 110) of “Change the destination to my mother-in-law's house and route us via a supermarket”, where the user depresses a physical button on the steering wheel of the car whilst saying “my mother-in-law's house”. It will be appreciated that, in various implementations, the information related to depressing the steering wheel button shown in FIG. 5B is not rendered (e.g., visually and/or audibly) for presentation to the user, i.e., this information may not be perceivable by a user. The mapping application, in this example, can be configured to process inputs using an LLM (e.g., the first LLM or the second LLM described herein) to accurately process and/or transcribe NL inputs and instruction inputs provided by users.

Referring specifically to FIG. 5C, by using the generative content system 120 (which e.g., may be implemented remotely from the client device 110, or may be implemented partially or wholly at the client device 110) to identify the classification of the instruction input (e.g., using an instruction input mapping, optionally stored in database 140A) as a steering wheel button input, corresponding instruction(s) may be identified. In this example, the instruction corresponding to the steering wheel button input (e.g., as defined by the instruction input mapping) may be a shortcut instruction to “Use address information from my personal address book”. In other words, in this specific example, the instruction input applied to the phrase “my mother-in-law's address” indicates that a personal address book (e.g., stored at the client device 110 or in client device database 110A) should be used to replace the shortcut portion of “my mother-in-law's address” in the NL input with shortcut data, i.e., the actual address as defined in the personal address book. It will be appreciated that, in various implementations, the NL input, classification, and instruction shown in FIG. 5C are not rendered (e.g., visually and/or audibly) for presentation to the user, i.e., this information may not be perceivable by a user.

The generative content system 120 can process the NL input and the instruction using an LLM (e.g., the first LLM or the second LLM described herein), to provide generative output which identifies a transcription of the NL input which is responsive to the instruction corresponding to the instruction input. Assume that the system provides the user with a notification or message 524 saying:
“Change destination to 123 Main St, London, W13 8JX and route us via a supermarket”.

In this specific example, it will be appreciated that an LLM can be trained/fine-tuned and prompted to identify an address corresponding to a mother-in-law of the user in the personal address book (which may also be processed as an input using the LLM) and to replace the appropriate part of the NL input (i.e., the shortcut portion) with the address (i.e., the shortcut data). The techniques described herein (and as illustrated with respect to FIGS. 5B and 5C) may provide a variety of technical advantages. In particular, the techniques may allow a user to provide customized and/or personalized instructions for processing and/or transcribing text via a voice interface in a computationally efficient manner. In this example, providing instructions in this manner is particularly beneficial in that it avoids the user having to stop driving in order to look up information (e.g., the address) and access an editing interface to insert the address, for example.

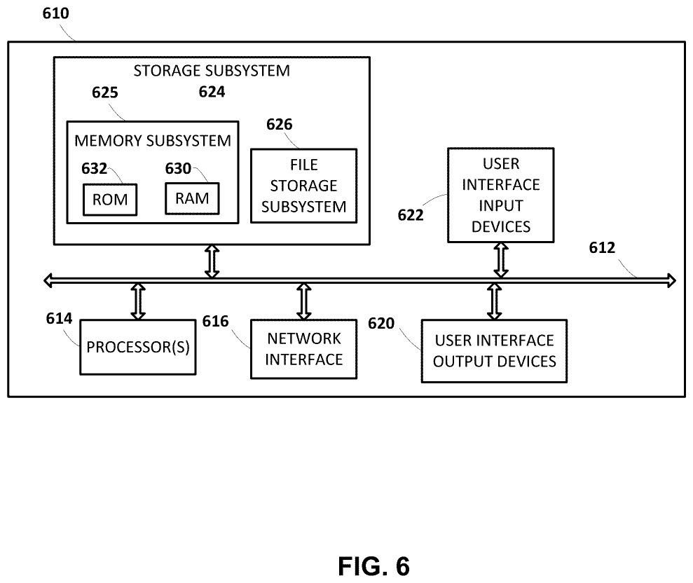

Turning now to FIG. 6, a block diagram of an example computing device 610 that may optionally be utilized to perform one or more aspects of techniques described herein is depicted. In some implementations, one or more of a client device (e.g., client device 110), generative content system component(s) or other cloud-based software application component(s) (e.g., component(s) of generative content system 120, ASR model(s) 150, and/or external system(s) 160), and/or other component(s) may comprise one or more components of the example computing device 610.

Computing device 610 typically includes at least one processor 614 which communicates with a number of peripheral devices via bus subsystem 612. These peripheral devices may include a storage subsystem 624, including, for example, a memory subsystem 625 and a file storage subsystem 626, user interface output devices 620, user interface input devices 622, and a network interface subsystem 616. The input and output devices allow user interaction with computing device 610. Network interface subsystem 616 provides an interface to outside networks and is coupled to corresponding interface devices in other computing devices.

User interface input devices 622 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 610 or onto a communication network.

User interface output devices 620 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 610 to the user or to another machine or computing device.

Storage subsystem 624 stores programming and data constructs that provide the functionality of some or all of the modules described herein. For example, the storage subsystem 624 may include the logic to perform selected aspects of the methods disclosed herein (e.g., as explained with respect to FIGS. 2A, 2B, 3, and 4), as well as to implement various components depicted in FIGS. 1, 2A, 2B, 5A, 5B, and 5C.

These software modules are generally executed by processor 614 alone or in combination with other processors. Memory 625 used in the storage subsystem 624 can include a number of memories including a main random-access memory (RAM) 630 for storage of instructions and data during program execution and a read only memory (ROM) 632 in which fixed instructions are stored. A file storage subsystem 626 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 626 in the storage subsystem 624, or in other machines accessible by the processor(s) 614.

Bus subsystem 612 provides a mechanism for letting the various components and subsystems of computing device 610 communicate with each other as intended. Although bus subsystem 612 is shown schematically as a single bus, alternative implementations of the bus subsystem 612 may use multiple busses.

Computing device 610 can be of varying types including a workstation, server, computing cluster, blade server, server farm, or any other data processing system or computing device. Due to the ever-changing nature of computers and networks, the description of computing device 610 depicted in FIG. 6 is intended only as a specific example for purposes of illustrating some implementations. Many other configurations of computing device 610 are possible having more or fewer components than the computing device depicted in FIG. 6.

In situations in which the systems described herein collect or otherwise monitor personal information about users (or make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

In some implementations, a method implemented by one or more processors is provided, and includes: receiving natural language (NL) input associated with a client device; processing, using a first large language model (LLM), first LLM input to generate corresponding first LLM output, the first LLM input including the NL input; identifying, based on the corresponding first LLM output, a dictation portion of the NL input and an instruction portion of the NL input, the instruction portion of the NL input including one or more instructions for transcription of the dictation portion of the NL input; processing, using the first LLM or a second LLM, second LLM input to generate corresponding second LLM output, the second LLM input including the dictation portion of the NL input and the instruction portion of the NL input; determining, based on the corresponding second LLM output, a transcription of the dictation portion of the NL input responsive to the one or more instructions for transcription of the dictation portion of the NL input; and causing the transcription of the dictation portion of the NL input to be rendered at the client device.

These and other implementations of technology disclosed herein can optionally include one or more of the following features.

In some implementations, the NL input can be based on a spoken voice input at the client device.

In some versions of those implementations, the NL input can include raw audio data and/or raw video data capturing the spoken voice input; or the NL input can include automatic speech recognition (ASR) data corresponding to the spoken voice input.

In some additional or alternative implementations, the method can further include:
subsequent to identifying the dictation portion of the NL input and the instruction portion of the NL input, causing an initial transcription of the dictation portion of the NL input and/or an initial transcription of the instruction portion of the NL input to be rendered at the client device.

In some versions of those implementations, the method can further include:
receiving feedback correcting the initial transcription of the dictation portion of the NL input and/or correcting the initial transcription of the instruction portion of the NL input; and
updating, responsive to the feedback, the dictation portion of the NL input and/or the instruction portion of the NL input for inclusion in the second LLM input.

In some additional or alternative implementations, the one or more instructions for transcription of the dictation portion of the NL input can include one or more formatting instructions.

In some versions of those implementations, the one or more formatting instructions can include at least one of: an instruction to format the dictation portion of the NL input using bullet points, where the transcription of the dictation portion of the NL input can include formatted bullet point text; and/or an instruction to format the dictation portion of the NL input as a list, where the transcription of the dictation portion of the NL input can include a formatted text list; and/or an instruction to format the dictation portion of the NL input according to a punctuation guideline, where the transcription of the dictation portion of the NL input can include text formatted according to the punctuation guideline; and/or an instruction to format the dictation portion of the NL input according to a structure guideline, where the transcription of the dictation portion of the NL input can include text formatted according to the structure guideline; and/or an instruction to extract information from the dictation portion of the NL input, where the transcription of the dictation portion of the NL input can include the extracted information.

In some additional or alternative implementations, the one or more instructions for transcription of the dictation portion of the NL input can include one or more correction instructions.

In some versions of those implementations, the one or more correction instructions can include at least one of: an instruction to correct one or more formatting errors in the dictation portion of the NL input, where the transcription of the dictation portion of the NL input does not include the one or more formatting errors; and/or an instruction to correct one or more spelling errors in the dictation portion of the NL input, where the transcription of the dictation portion of the NL input does not include the one or more spelling errors; and/or an instruction to correct one or more recognition errors in the dictation portion of the NL input, where the transcription of the dictation portion of the NL input does not include the one or more recognition errors.

In some additional or alternative implementations, the one or more instructions for transcription of the dictation portion of the NL input can include one or more shortcut instructions, where the one or more shortcut instructions can include an instruction to replace a shortcut portion of the dictation portion of the NL input with shortcut data, where the transcription of the dictation portion of the NL input can include the shortcut data in lieu of the shortcut portion.

In some implementations, a method implemented by one or more processors is provided, and includes: receiving natural language (NL) input associated with a client device; identifying one or more instruction inputs associated with the NL input; for each instruction input of the one or more instruction inputs: determining, based on an instruction input mapping, a classification of the respective instruction input, and determining, based on the classification of the respective instruction input, a respective instruction for transcription of the NL input; processing, using a large language model (LLM), first LLM input to generate corresponding first LLM output, the first LLM input including the NL input and one or more of the respective instructions for transcription of the NL input; determining, based on the corresponding first LLM output, a transcription of the NL input responsive to the one or more instructions for transcription of the NL input; and causing the transcription of the NL input to be rendered at the client device.

These and other implementations of technology disclosed herein can optionally include one or more of the following features.

In some implementations, the NL input can be based on a spoken voice input at the client device.

In some versions of those implementations, the NL input can include raw audio data and/or raw video data capturing the spoken voice input; or the NL input can include automatic speech recognition (ASR) data corresponding to the spoken voice input.

In some additional or alternative implementations, the instruction input mapping can include one or more input types, the input types including at least one of: one or more keyboard inputs, one or more mid-air gesture inputs, one or more physical button inputs, one or more inertial measurement unit (IMU) inputs, one or more touchscreen inputs, and/or one or more mouse inputs; and determining the classification of the respective instruction input can include identifying an input type of the one or more input types which corresponds to the respective instruction input.

In some versions of those implementations, the instruction input mapping can further include one or more instructions for transcription of the NL input; and determining the respective instruction for transcription of the NL input can include identifying an instruction of the one or more instructions which corresponds to the classification of the respective instruction input.

In some additional or alternative implementations, the method can further include:
identifying data for updating the instruction input mapping, the data including a correspondence between an input type of the one or more input types and an instruction of the one or more instructions for transcription of the NL input; and updating, responsive to the data, the instruction input mapping to reflect the correspondence between the input type of the one or more input types and the instruction of the one or more instructions for transcription of the NL input.

In some versions of those implementations, the data for updating the instruction input mapping can be based on user input received at the client device.

In some versions of those implementations, the data for updating the instruction input mapping can be machine-learned based on historical NL inputs and/or historical instruction inputs associated with the historical NL inputs.

In addition, some implementations include one or more processors (e.g., central processing unit(s) (CPU(s)), graphics processing unit(s) (GPU(s)), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more computer-readable storage media (e.g., transitory and/or non-transitory) storing computer instructions executable by one or more processors to perform any of the aforementioned methods. Some implementations also include a computer program product including instructions executable by one or more processors to perform any of the aforementioned methods.

What is claimed is:

1. A method implemented by one or more processors, the method comprising:
receiving natural language (NL) input associated with a client device;
processing, using a first large language model (LLM), first LLM input to generate corresponding first LLM output, the first LLM input comprising the NL input;
identifying, based on the corresponding first LLM output, a dictation portion of the NL input and an instruction portion of the NL input, the instruction portion of the NL input comprising one or more instructions for transcription of the dictation portion of the NL input;
processing, using the first LLM or a second LLM, second LLM input to generate corresponding second LLM output, the second LLM input comprising the dictation portion of the NL input and the instruction portion of the NL input;
determining, based on the corresponding second LLM output, a transcription of the dictation portion of the NL input responsive to the one or more instructions for transcription of the dictation portion of the NL input; and
causing the transcription of the dictation portion of the NL input to be rendered at the client device.

2. The method of claim 1, wherein the NL input is based on a spoken voice input at the client device.

3. The method of claim 2, wherein:
the NL input comprises raw audio data and/or raw video data capturing the spoken voice input; or
the NL input comprises automatic speech recognition (ASR) data corresponding to the spoken voice input.

4. The method of claim 1, further comprising:
subsequent to identifying the dictation portion of the NL input and the instruction portion of the NL input, causing an initial transcription of the dictation portion of the NL input and/or an initial transcription of the instruction portion of the NL input to be rendered at the client device.

5. The method of claim 4, further comprising:
receiving feedback correcting the initial transcription of the dictation portion of the NL input and/or correcting the initial transcription of the instruction portion of the NL input; and
updating, responsive to the feedback, the dictation portion of the NL input and/or the instruction portion of the NL input for inclusion in the second LLM input.

6. The method of claim 1, wherein the one or more instructions for transcription of the dictation portion of the NL input comprise one or more formatting instructions.

7. The method of claim 6, wherein the one or more formatting instructions comprise at least one of:
an instruction to format the dictation portion of the NL input using bullet points, wherein the transcription of the dictation portion of the NL input comprises formatted bullet point text; and/or
an instruction to format the dictation portion of the NL input as a list, wherein the transcription of the dictation portion of the NL input comprises a formatted text list; and/or
an instruction to format the dictation portion of the NL input according to a punctuation guideline, wherein the transcription of the dictation portion of the NL input comprises text formatted according to the punctuation guideline; and/or
an instruction to format the dictation portion of the NL input according to a structure guideline, wherein the transcription of the dictation portion of the NL input comprises text formatted according to the structure guideline; and/or
an instruction to extract information from the dictation portion of the NL input, wherein the transcription of the dictation portion of the NL input comprises the extracted information.

8. The method of claim 1, wherein the one or more instructions for transcription of the dictation portion of the NL input comprise one or more correction instructions.

9. The method of claim 8, wherein the one or more correction instructions comprise at least one of:
an instruction to correct one or more formatting errors in the dictation portion of the NL input, wherein the transcription of the dictation portion of the NL input does not comprise the one or more formatting errors; and/or
an instruction to correct one or more spelling errors in the dictation portion of the NL input, wherein the transcription of the dictation portion of the NL input does not comprise the one or more spelling errors; and/or
an instruction to correct one or more recognition errors in the dictation portion of the NL input, wherein the transcription of the dictation portion of the NL input does not comprise the one or more recognition errors.

10. The method of claim 1, wherein the one or more instructions for transcription of the dictation portion of the NL input comprise one or more shortcut instructions, wherein the one or more shortcut instructions comprise an instruction to replace a shortcut portion of the dictation portion of the NL input with shortcut data, wherein the transcription of the dictation portion of the NL input comprises the shortcut data in lieu of the shortcut portion.

11. A method implemented by one or more processors, the method comprising:
receiving natural language (NL) input associated with a client device;
identifying one or more instruction inputs associated with the NL input;
for each instruction input of the one or more instruction inputs:
determining, based on an instruction input mapping, a classification of the respective instruction input, and
determining, based on the classification of the respective instruction input, a respective instruction for transcription of the NL input;
processing, using a large language model (LLM), first LLM input to generate corresponding first LLM output, the first LLM input comprising the NL input and one or more of the respective instructions for transcription of the NL input;
determining, based on the corresponding first LLM output, a transcription of the NL input responsive to the one or more instructions for transcription of the NL input; and
causing the transcription of the NL input to be rendered at the client device.

12. The method of claim 11, wherein the NL input is based on a spoken voice input at the client device.

13. The method of claim 12, wherein:
the NL input comprises raw audio data and/or raw video data capturing the spoken voice input; or
the NL input comprises automatic speech recognition (ASR) data corresponding to the spoken voice input.

14. The method of claim 11, wherein:
the instruction input mapping comprises one or more input types, the input types comprising at least one of: one or more keyboard inputs, one or more mid-air gesture inputs, one or more physical button inputs, one or more inertial measurement unit (IMU) inputs, one or more touchscreen inputs, and/or one or more mouse inputs; and
determining the classification of the respective instruction input comprises identifying an input type of the one or more input types which corresponds to the respective instruction input.

15. The method of claim 14, wherein:
the instruction input mapping further comprises one or more instructions for transcription of the NL input; and
determining the respective instruction for transcription of the NL input comprises identifying an instruction of the one or more instructions which corresponds to the classification of the respective instruction input.

16. The method of claim 15, wherein:
the one or more instructions for transcription of the NL input comprise at least one of: one or more dictation mode instructions, one or more instruction mode instructions, one or more formatting instructions, one or more correction instructions, and/or one or more shortcut instructions.

17. The method of claim 15, further comprising:
identifying data for updating the instruction input mapping, the data comprising a correspondence between an input type of the one or more input types and an instruction of the one or more instructions for transcription of the NL input; and
updating, responsive to the data, the instruction input mapping to reflect the correspondence between the input type of the one or more input types and the instruction of the one or more instructions for transcription of the NL input.

18. The method of claim 17, wherein the data for updating the instruction input mapping is based on user input received at the client device.

19. The method of claim 17, wherein the data for updating the instruction input mapping is machine-learned based on historical NL inputs and/or historical instruction inputs associated with the historical NL inputs.

20. A system comprising:
at least one processor; and
memory storing instructions that, when executed by the at least one processor, cause the at least one processor to:
receive natural language (NL) input associated with a client device;
process, using a first large language model (LLM), first LLM input to generate corresponding first LLM output, the first LLM input comprising the NL input;
identify, based on the corresponding first LLM output, a dictation portion of the NL input and an instruction portion of the NL input, the instruction portion of the NL input comprising one or more instructions for transcription of the dictation portion of the NL input;
process, using the first LLM or a second LLM, second LLM input to generate corresponding second LLM output, the second LLM input comprising the dictation portion of the NL input and the instruction portion of the NL input;
determine, based on the corresponding second LLM output, a transcription of the dictation portion of the NL input responsive to the one or more instructions for transcription of the dictation portion of the NL input; and
cause the transcription of the dictation portion of the NL input to be rendered at the client device.
